(19) United States
(12) Patent Application Publication
(10) Pub. No.: US 2025/0070503 A1
(43) Pub. Date: Feb. 27, 2025

(54) MALE CONNECTOR AND CONNECTOR PAIR

(71) Applicant: SUMITOMO WIRING SYSTEMS, LTD., Mie (JP)

(72) Inventor: Tatsuaki TOIDA, Mie (JP)

(21) Appl. No.: 18/720,791

(22) PCT Filed: Dec. 6, 2022
(86) PCT No.: PCT/JP2022/044922

§ 371 Date: Jun. 17, 2024

(30) Foreign Application Priority Data
Dec. 22, 2021 (JP) 2021-208425

(51) Int. Cl. H01R 13/52; H01R 13/502

(52) U.S. Cl. CPC H01R 13/5205; H01R 13/502

(57) ABSTRACT

A male connector 11 according to the present disclosure fits together with a female connector 12 along a fitting direction, said male connector 11 comprising: a male housing 13 that has a male hood part 17; a male terminal that has a tab which projects inside the male hood part 17 and is attached to the male housing 13; a male electric wire that is attached to the male terminal; a male rubber stopper that is fitted to the outside of the male electric wire; and a moving plate 15 that is provided inside the male hood part 17 and that is movable between an initial position in a state in which the tab is positioned and a fitting position which is rearward of the initial position in the fitting direction. The male housing 13 has a male cavity that accommodates the male terminal. The male cavity has a cylindrical male seal part inside which the male rubber stopper fits. The inner surface of the male seal part makes close contact with the male rubber stopper. The male housing 13 has a moving plate lock part 35 that engages with the moving plate 15 to hold the moving plate 15 at the initial position, and extends forward in the fitting direction in a region inward of an imaginary male seal surface 42, which is an imaginary forward extension of the inner surface of the male seal part in the fitting direction.

### TECHNICAL FIELD

The present disclosure relates to a male connector and a connector pair.

### BACKGROUND

A connector described in Patent Document 1 (Japanese Patent Laid-Open Publication No. 2019-212404) is provided with a housing including a receptacle, terminal fittings each including a tab projecting into the receptacle and a moving plate to be inserted into the receptacle and movable between a temporary locking position and a connection position backward of the temporary locking position while positioning the tabs. The moving plate is moved from the temporary locking position to the connection position by being pushed by a mating housing of a mating connector fit into the receptacle.

The moving plate includes a temporary locking portion extending toward the housing. The housing includes a first interfering portion and a second interfering portion to be engaged with an interference projection of the temporary locking portion.

The housing is formed by injection-molding a synthetic resin material using a mold, which is opened in a connection direction. Thus, the housing includes a mold removal hole (recess) for molding the first and second interfering portions. The mold removal hole is open in the rear surface of the housing. Thus, the rear surface of the housing is collectively sealed by one one-piece rubber plug. The one-piece rubber plug is retained and held in the housing by a rear holder.

### PRIOR ART DOCUMENT

### Patent Document

Patent Document 1: JP 2019-212404 A

### SUMMARY OF THE INVENTION

### Problems to be Solved

Since the one-piece rubber plug is formed to widely cover the rear surface of the housing, the one-piece rubber plug tends to be enlarged. Thus, there is a problem of increasing the manufacturing cost of the connector. Further, in the case of collectively sealing the rear surface of the housing by one one-piece rubber plug, there is a problem of reducing sealability as compared to the case where cavities are individually sealed by fitting rubber plugs into the cavities accommodating the terminal fittings.

The present disclosure was completed on the basis of the above situation and aims to provide a male connector and a connector pair with reduced manufacturing cost and improved sealability.

### Means to Solve the Problem

The present disclosure is directed to a male connector to be connected to a female connector along a connection direction, the male connector being provided with a male housing including a male receptacle, a male terminal to be mounted into the male housing, the male terminal including a tab projecting into the male receptable, a male wire to be attached to the male terminal, a male rubber plug to be externally fit to the male wire, and a moving plate to be disposed in the male receptacle, the moving plate being movable between an initial position and a connection position behind the initial position in the connection direction while positioning the tab, the male housing including a male cavity for accommodating the male terminal, the male cavity including a tubular male sealing portion, the male rubber plug being fit into the male sealing portion, an inner surface of the male sealing portion being held in close contact with the male rubber plug, and the male housing including a moving plate lock portion in a region inside a virtual male sealing surface set by extending the inner surface of the male sealing portion forward in the connection direction, the moving plate lock portion projecting forward in the connection direction, the moving plate lock portion holding the moving plate at the initial position by being engaged with the moving plate.

### Effect of the Invention

According to the present disclosure, it is possible to reduce manufacturing cost and improve sealability.

### BRIEF DESCRIPTION OF THE DRAWINGS

FIG. 1 is a section showing a connector pair according to one embodiment.

FIG. 2 is an exploded perspective view showing a male connector.

FIG. 3 is a front view showing the male connector.

FIG. 4 is a perspective view showing the male connector.

FIG. 5 is an exploded perspective view showing a female connector.

FIG. 6 is a perspective view showing the female connector.

FIG. 7 is a front view showing the female connector.

FIG. 8 is a partial enlarged section showing a state where the male connector and the female connector are lightly connected.

FIG. 9 is a section along IX-IX in FIG. 8.

FIG. 10 is a partial enlarged section showing a state where a retractable lock portion is resiliently deflected.

FIG. 11 is a section along XI-XI in FIG. 10.

FIG. 12 is a partial enlarged section showing a state where the retractable lock portion and a retractable lock receiving portion are engaged.

FIG. 13 is a section along XIII-XIII in FIG. 12.

FIG. 14 is a partial enlarged section showing a state where a female housing body portion, a female retainer and a moving plate are in contact.

FIG. 15 is a section along XV-XV in FIG. 14.

FIG. 16 is a partial enlarged section showing a state where the connection of the male connector and the female connector is completed.

FIG. 17 is a section along XVII-XVII in FIG. 16.

### DETAILED DESCRIPTION TO EXECUTE THE INVENTION

### Description of Embodiments of Present Disclosure

First, embodiments of the present disclosure are listed and described.

(1) The male connector of the present disclosure is to be connected to a female connector along a connection direction and provided with a male housing including a male receptacle, a male terminal to be mounted into the male housing, the male terminal including a tab projecting into the male receptable, a male wire to be attached to the male terminal, a male rubber plug to be externally fit to the male wire, and a moving plate to be disposed in the male receptacle, the moving plate being movable between an initial position and a connection position behind the initial position in the connection direction while positioning the tab, the male housing including a male cavity for accommodating the male terminal, the male cavity including a tubular male sealing portion, the male rubber plug being fit into the male sealing portion, an inner surface of the male sealing portion being held in close contact with the male rubber plug, and the male housing including a moving plate lock portion in a region inside a virtual male sealing surface set by extending the inner surface of the male sealing portion forward in the connection direction, the moving plate lock portion projecting forward in the connection direction, the moving plate lock portion holding the moving plate at the initial position by being engaged with the moving plate.

In forming the moving plate lock portion using a mold, which is opened forward and rearward in the connection direction, the male cavity can serve as a mold removal hole. In this way, the mold removal hole needs not be separately formed in the male housing, wherefore the rear surface of the male housing needs not be collectively sealed by one one-piece rubber plug. As a result, the male cavity can be individually sealed by the male rubber plug. Thus, manufacturing cost can be reduced as compared to the case of using the one-piece rubber plug. Further, since the male rubber plug externally fit to the male wire is held in close contact with the male sealing surface provided on the male sealing portion of the male cavity, the waterproofness of the male housing can be improved as compared to the case where the rear surface of the male housing is collectively sealed by one rubber plug.

(2) Preferably, the moving plate lock portion is formed to be resiliently deformable in a direction intersecting an extension direction of the tab and parallel to plate surfaces of the tab.

Even if the moving plate lock portion is resiliently deformed, the interference of the moving plate lock portion with the tab can be avoided. In this way, a region where the moving plate lock portion is resiliently deformed can be provided without enlarging the male connector.

(3) Preferably, the moving plate lock portion includes two resilient deflecting portions extending forward in the connection direction and a reinforcing portion coupling tip parts of the two resilient deflecting portions to each other.

Since the resilient deflecting portions can be strengthened by the reinforcing portion, the strength of the moving plate lock portion can be improved. In this way, unintended deformation of the moving plate lock portion is suppressed, with the result that an unintended movement of the moving plate from the initial position can be suppressed.

(4) A connector pair of the present disclosure is provided with the male connector of any one of (1) to (3) described above and a female connector to be connected to the male connector, the female connector including a female housing having a female receptacle to be externally fit to the male receptacle, a female terminal to be mounted into the female housing and electrically connected to the male terminal, a female wire to be attached to the female terminal, and a female rubber plug to be externally fit to the female wire, the female housing including a female cavity for accommodating the female terminal, the female cavity including a tubular female sealing portion, the female rubber plug being fit into the female sealing portion, an inner surface of the female sealing portion being held in close contact with the female rubber plug, and the female housing including a moving plate lock releasing portion in a region inside a virtual female sealing surface set by extending the inner surface of the female sealing portion forward in the connection direction, the moving plate lock releasing portion projecting forward in the connection direction, the moving plate lock releasing portion disengaging the moving plate and the moving plate lock portion by resiliently deforming the moving plate lock portion.

In forming the moving plate lock releasing portion using a mold, which is opened forward and rearward in the connection direction, the female cavity can serve as a mold removal hole. In this way, the mold removal hole needs not be separately formed in the female housing, wherefore the rear surface of the female housing needs not be collectively sealed by one one-piece rubber plug. As a result, the female cavity can be individually sealed by the female rubber plug. Thus, manufacturing cost can be reduced as compared to the case of using the one-piece rubber plug. Further, since the female rubber plug externally fit to the female wire is held in close contact with the female sealing surface provided on the female sealing portion of the female cavity, waterproofness can be improved as compared to the case of using the one-piece rubber plug.

(5) The moving plate includes a resiliently deformable retractable lock portion projecting forward in the connection direction, the female connector includes another female terminal to be mounted into the female housing and different from the female terminal, another female wire to be attached to the other female terminal and another female rubber plug to be externally fit to the other female wire, the female housing includes a retractable lock receiving portion lockable by the retractable lock portion, the female housing includes another female cavity for accommodating the other female terminal, the other female cavity including another tubular female sealing portion, the other female rubber plug being fit into the other female sealing portion, and an inner surface of the other female sealing portion is held in close contact with the other female rubber plug, and the female housing includes the retractable lock receiving portion in a region inside another virtual female sealing surface set by extending the inner surface of the other female sealing portion in the connection direction.

In forming the retractable lock receiving portion using a mold, which is opened forward and rearward, the other female cavity can serve as a mold removal hole. In this way, the mold removal hole needs not be separately formed in the female housing, wherefore the rear surface of the female housing needs not be collectively sealed by one one-piece rubber plug. As a result, the other female cavity can be individually sealed by the other female rubber plug. Thus, manufacturing cost can be reduced as compared to the case of using the one-piece rubber plug. Further, since the other female rubber plug externally fit to the other female wire is held in close contact with the other female sealing surface provided on the other female sealing portion of the other female cavity, waterproofness can be improved as compared to the case of using the one-piece rubber plug.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

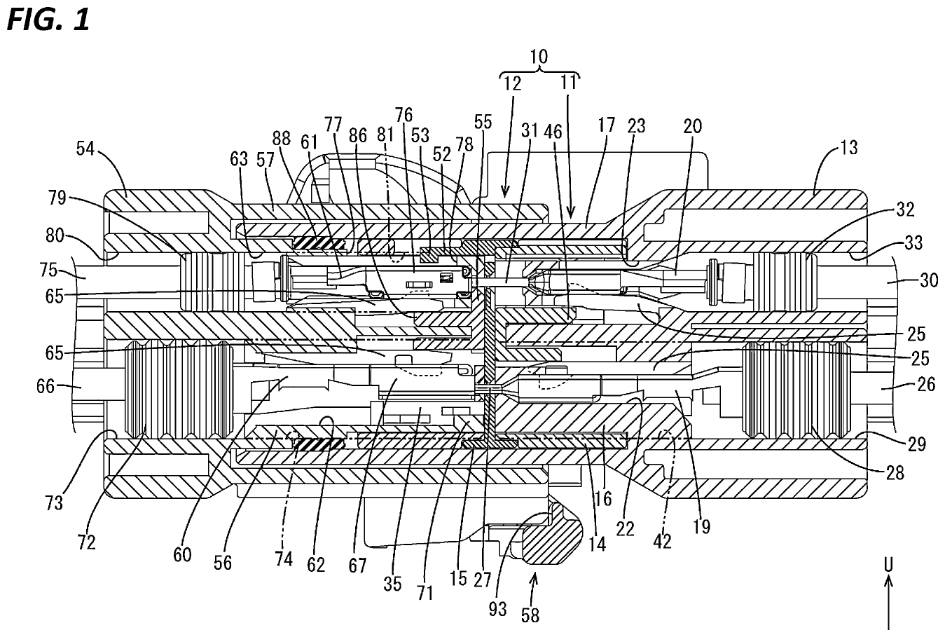

One embodiment of the present disclosure is described with reference to FIGS. 1 to 17. As shown in FIG. 1, a connector pair 10 according to the embodiment is provided with a male connector 11 and a female connector 12 connectable to each other along a connection direction. The connection direction of the male and female connectors 11, 12 is referred to as a front-rear direction, and surface sides facing each other at the start of connection of the male and female connectors 11, 12 are referred to as front sides. Concerning a vertical direction and a lateral direction, a direction indicted by an arrow U and a direction indicated by an arrow L in figures are shown as an upward direction and a leftward direction as appropriate. Further, for a plurality of identical members, only some members may be denoted by a reference sign and the others may not be denoted by the reference sign.

### (Male Connector 11)

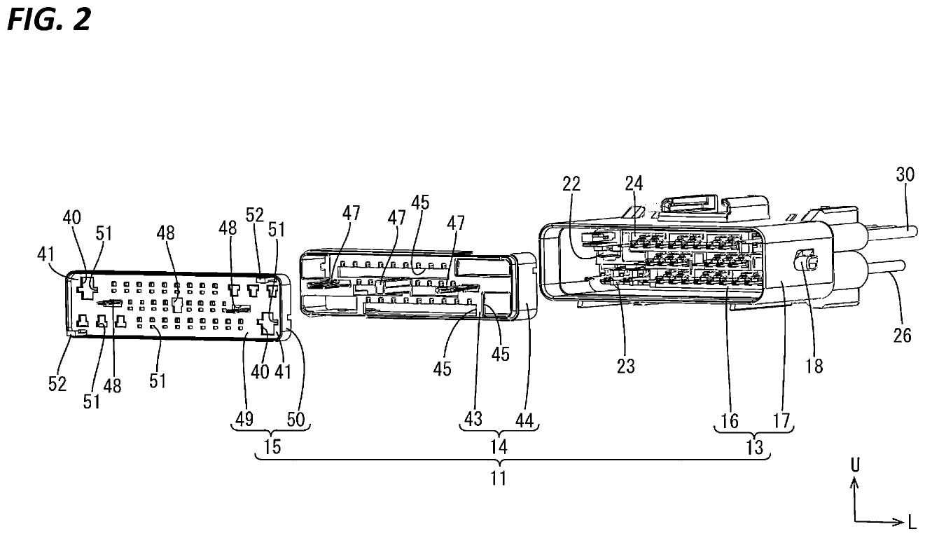

As shown in FIG. 2, the male connector 11 is provided with a male housing 13, a male retainer 14 and a moving plate 15.

### (Male Housing 13)

The male housing 13 is formed into a predetermined shape by injection-molding a synthetic resin material. As shown in FIG. 2, the male housing 13 includes a male housing body portion 16 having a substantially rectangular parallelepiped shape and a male receptacle 17 substantially in the form of a rectangular tube projecting forward from the male housing body portion 16. Column-like cam pins 18 projecting outward are provided on both left and right side edge parts of the male receptacle 17.

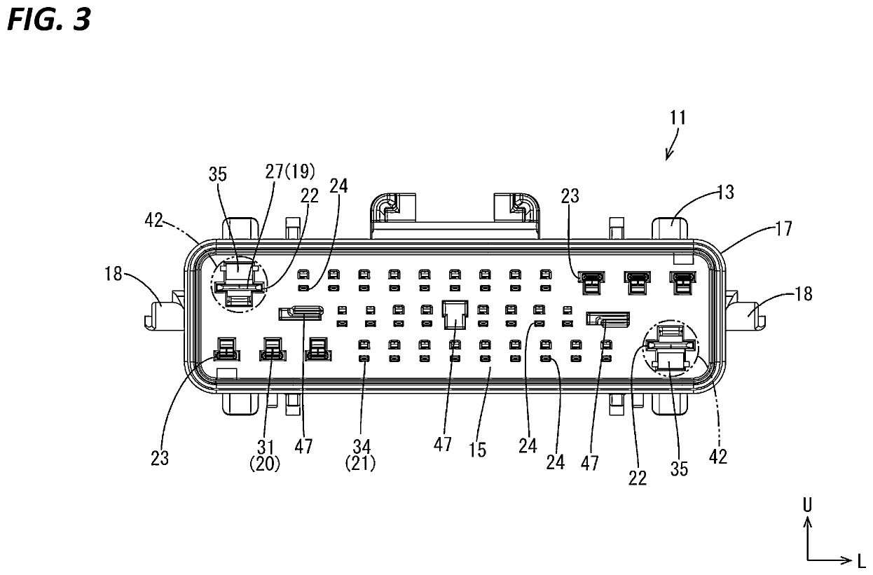

As shown in FIG. 3, a plurality of (two in this embodiment) first male terminals 19 (an example of a male terminal), a plurality of (six in this embodiment) second male terminals 20 and a plurality of (twenty six in this embodiment) third male terminals 21 are accommodated in the male housing body portion 16. Concerning lengths in the front-rear direction, widths in the lateral direction and heights in the vertical direction, the first male terminals 19 are largest, the second male terminals 20 are second largest and the third male terminals 21 are smallest.

As shown in FIG. 3, the male housing body portion 16 includes a plurality of (two in this embodiment) first male cavities 22 (an example of a male cavity), a plurality of (six in this embodiment) second male cavities 23 and a plurality of (twenty six in this embodiment) third male cavities 24. The first, second and third male cavities 22, 23 and 24 penetrate through the male housing body portion 16 in the front-rear direction.

As shown in FIG. 3, the first male cavities 22 are respectively disposed in a right upper part and a left lower part of the male housing body portion 16.

As shown in FIG. 3, three second male cavities 23 arranged in the lateral direction are disposed in a left upper part of the male housing body portion 16, and three second male cavities 23 arranged in the lateral direction are disposed in a right lower part of the male housing body portion 16.

As shown in FIG. 3, the third male cavities 24 are arranged in the lateral direction in three stages in the vertical direction. Nine third male cavities 24 are disposed in an upper stage, eight third male cavities 24 are disposed in a middle stage and nine third male cavities 24 are disposed in a lower stage.

The inner wall of each of the first, second and third male cavities 22, 23 and 24 is formed with a resiliently deformable male locking lance 25 projecting forward (see FIG. 1).

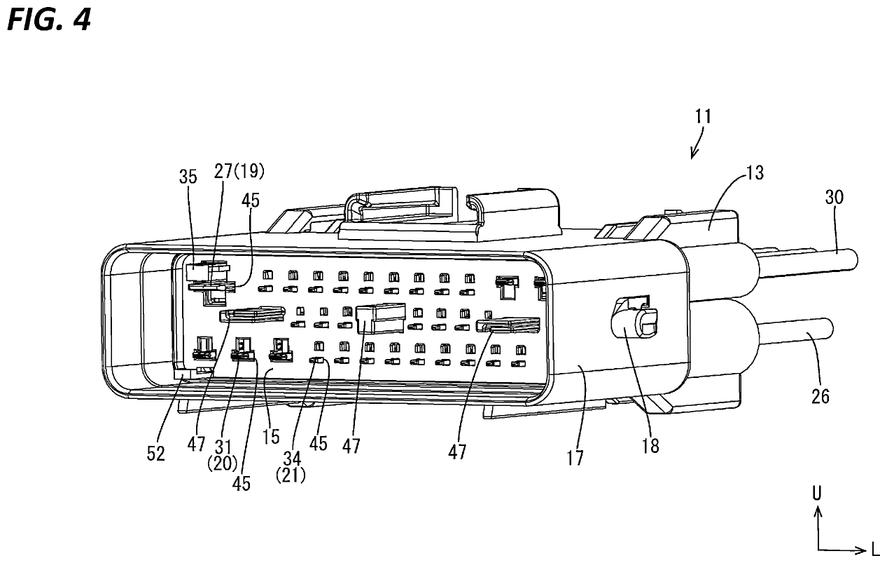

The first male terminal 19 is accommodated in the first male cavity 22. The first male terminal 19 is connected to a front end part of a first male wire 26 (an example of a male wire). A front end part of the first male terminal 19 is provided with a first tab 27 (an example of a tab) in the form of a flat plate projecting forward. The male locking lance 25 resiliently locks the first male terminal 19, whereby the first male terminal 19 is retained and held in the first male cavity 22. With the first male terminal 19 held in the male cavity 22, the first tab 27 projects into the male receptacle 17. Plate surfaces of the first tab 27 are facing in the vertical direction (see FIG. 4).

As shown in FIG. 1, a first male rubber plug 28 (an example of a male rubber plug) made of rubber is externally fit to the front end part of the first male wire 26. In this way, an outer peripheral part of the first male wire 26 and the inner peripheral surface of the first male rubber plug 28 are held in close contact, with the result that liquid-tight sealing is provided between the first male wire 26 and the first male rubber plug 28. The first male rubber plug 28 has a substantially hollow cylindrical shape. A rear end part of the first male cavity 22 is formed with a first male sealing portion 29 (an example of a male sealing portion), into which the first male rubber plug 28 is fit. The first male sealing portion 29 has a hollow cylindrical shape. An inner diameter of the first male sealing portion 29 is set to be somewhat smaller than an outer diameter of the first male rubber plug 28. In this way, the first male rubber plug 28 is resiliently compressed while being fit in the first male sealing portion 29. As a result, an outer peripheral part of the first male rubber plug 28 is held in close contact with the inner peripheral surface of the first male sealing portion 29, wherefore liquid-tight sealing is provided between the first male rubber plug 28 and the first male cavity 22.

The second male terminal 20 is accommodated in the second male cavity 23. The second male terminal 20 is connected to a front end part of a second male wire 30. A front end part of the second male terminal 20 is provided with a second tab 31 in the form of a flat plate projecting forward. The male locking lance 25 resiliently locks the second male terminal 20, whereby the second male terminal 20 is retained and held in the second male cavity 23. With the second male terminal 20 held in the male cavity 23, the second tab 31 projects into the male receptacle 17. Plate surfaces of the second tab 31 are facing in the vertical direction.

A second male rubber plug 32 made of rubber is externally fit to the front end part of the second male wire 30. In this way, an outer peripheral part of the second male wire 30 and the inner peripheral surface of the second male rubber plug 32 are held in close contact, with the result that liquid-tight sealing is provided between the second male wire 30 and the second male rubber plug 32. The second male rubber plug 32 has a substantially hollow cylindrical shape. A rear end part of the second male cavity 23 is formed with a second male sealing portion 33, into which the second male rubber plug 32 is fit. The second male sealing portion 33 has a hollow cylindrical shape. An inner diameter of the second male sealing portion 33 is set to be somewhat smaller than an outer diameter of the second male rubber plug 32. In this way, the second male rubber plug 32 is resiliently compressed while being fit in the second male sealing portion 33. As a result, an outer peripheral part of the second male rubber plug 32 is held in close contact with the inner peripheral surface of the second male sealing portion 33, wherefore liquid-tight sealing is provided between the second male rubber plug 32 and the second male cavity 23.

The third male terminal 21 is accommodated in the third male cavity 24. The third male terminal 21 is connected to a front end part of a third male wire. A front end part of the third male terminal 21 is provided with a third tab 34 in the form of a flat plate projecting forward. The male locking lance 25 resiliently locks the third male terminal 21, whereby the third male terminal 21 is retained and held in the third male cavity 24. With the third male terminal 21 held in the male cavity 24, the third tab 34 projects into the male receptacle 17. Plate surfaces of the third tab 34 are facing in the vertical direction.

A third male rubber plug (not shown) made of rubber is externally fit to the front end part of the third male wire. In this way, an outer peripheral part of the third male wire and the inner peripheral surface of the third male rubber plug are held in close contact, with the result that liquid-tight sealing is provided between the third male wire and the third male rubber plug. The third male rubber plug has a substantially hollow cylindrical shape. A rear end part of the third male cavity 24 is formed with a third male sealing portion (not shown), into which the third male rubber plug is fit. The third male sealing portion has a hollow cylindrical shape. An inner diameter of the third male sealing portion is set to be somewhat smaller than an outer diameter of the third male rubber plug. In this way, the third male rubber plug is resiliently compressed while being fit in the third male sealing portion. As a result, an outer peripheral part of the third male rubber plug is held in close contact with the inner peripheral surface of the third male sealing portion, wherefore liquid-tight sealing is provided between the third male rubber plug and the third male cavity 24.

A front end part of the male housing body portion 16 is arranged apart from the male receptacle 17 in a circumferential direction. Out of the front end part of the male housing body portion 16, parts located in front of the first male cavities 22 are formed with moving plate lock portions 35 projecting forward. The moving plate lock portions 35 are provided in a right upper part and a left lower part of the front end part of the male housing body portion 16 (see FIG. 3).

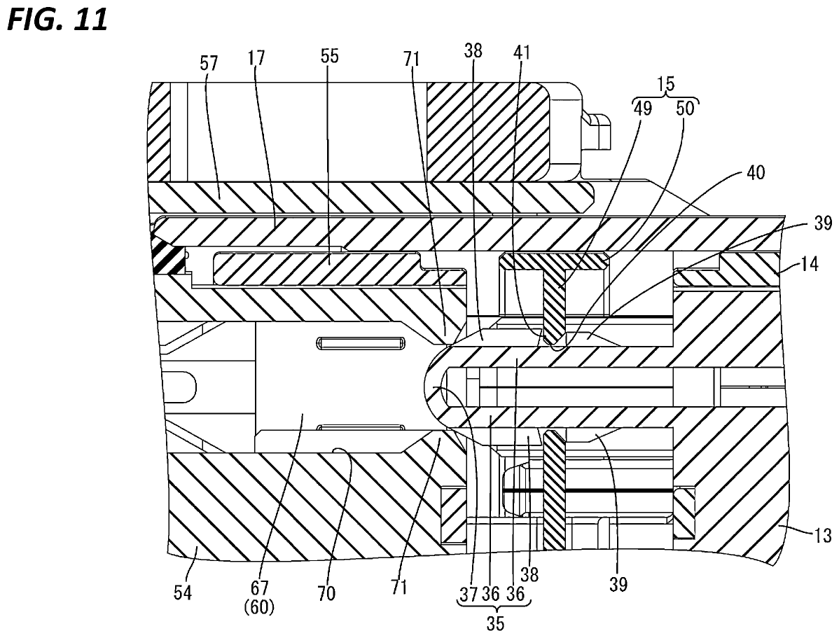

As shown in FIG. 11, the moving plate lock portion 35 includes two plate-like resilient deflecting portions 36 extending forward and a reinforcing portion 37 coupling front end parts of the two resilient deflecting portions 36 to each other. The moving plate lock portion 35 is U-shaped as a whole when viewed from above. Plate surfaces of the resilient deflecting portions 36 are facing in the lateral direction, and the resilient deflecting portions 36 are provided to be resiliently deformable in the lateral direction. In other words, the resilient deflecting portions 36 are provided to be resiliently deformable in directions intersecting an extension direction (front-rear direction) of the first tab 27 and parallel to the plate surfaces of the first tab 27. The front end parts of the two resilient deflecting portions 36 are integrally coupled by the reinforcing portion 37. In this way, the strength of the resilient deflecting portions 36 is reinforced when the two resilient deflecting portions 36 are resiliently deformed in directions toward each other.

A front retaining portion 38 and a rear retaining portion 39 provided behind the front retaining portion 38 are formed to project on the outer surface of each of the two resilient deflecting portions 36. The front and rear retaining portions 38, 39 are spaced apart in the front-rear direction. A moving plate lock receiving portion 41 formed on a hole edge part of an engaging hole 40 of the moving plate 15 to be described later is locked between the front and rear retaining portions 38, 39. The front and rear retaining portions 38, 39 are also shifted in the vertical direction. The front surface of the front retaining portion 38 is gently inclined, and the rear surface thereof is steeply formed. Further, the front surface of the rear retaining portion 39 is steeply formed and the rear surface thereof is gently inclined.

As shown in FIGS. 1 and 3, a virtual surface set by extending the inner surface of the first male sealing portion 29 forward is a virtual male sealing surface 42. The virtual male sealing surface 42 is a virtual surface extending forward of the first male sealing portion 29 and having a hollow cylindrical shape. The moving plate lock portion 35 is formed in a region inside this virtual male sealing surface 42. In this way, when the male housing 13 is molded by a mold, which is opened in the front-rear direction, the first male cavities 22 can serve as mold removal holes for forming the moving plate lock portions 35.

### (Male Retainer 14)

The male retainer 14 is mounted on the front end part of the male housing body portion 16 from front. The male retainer 14 is made of synthetic resin and includes a plate-like front wall portion 43 and a peripheral wall portion 44 extending rearward from a peripheral edge part of the front wall portion 43 (see FIG. 2). The peripheral wall portion 44 of the male retainer 14 is externally fit to the front end part of the male housing body portion 16.

A plurality of male retainer-side insertion holes 45 penetrate through the front wall portion 43 in the front-rear direction. The first, second and third tabs 27, 31 and 34 are respectively inserted through the respective male retainer-side insertion holes 45 (see FIG. 4).

As shown in FIG. 1, a plurality of male deflection restricting portions 46 projecting rearward are formed on the rear surface of the front wall portion 43. The male deflection restricting portion 46 is in the form of a plate flat in the vertical direction and extending in the lateral direction. When the male retainer 14 is mounted at a proper position on the male housing body portion 16, the male deflection restricting portions 46 enter deflection spaces for the male locking lances 25. In this way, the male locking lances 25 are suppressed from being deflected and deformed, wherefore the first, second and third male terminals 19, 20 and 21 are secondarily retained in the male housing body portion 16.

As shown in FIG. 2, a plurality of (three in this embodiment) guide portions 47 projecting forward are provided near a center in the vertical direction on the front surface of the front wall portion 43. The guide portions 47 are respectively inserted into moving plate through holes 48 of the moving plate 15 to be described later and guide the moving plates 15 when the moving plate 15 moves in the front-rear direction.

### (Moving Plate 15)

The moving plate 15 is made of synthetic resin and includes, as shown in FIG. 2, a plate-like plate body 49 and a peripheral wall portion 50 extending forward and rearward from an outer peripheral edge part of the plate body 49. The moving plate 15 is inserted into the male receptacle 17 with plate surfaces of the plate body 49 facing in the front-rear direction, thereby being disposed in the male receptacle 17.

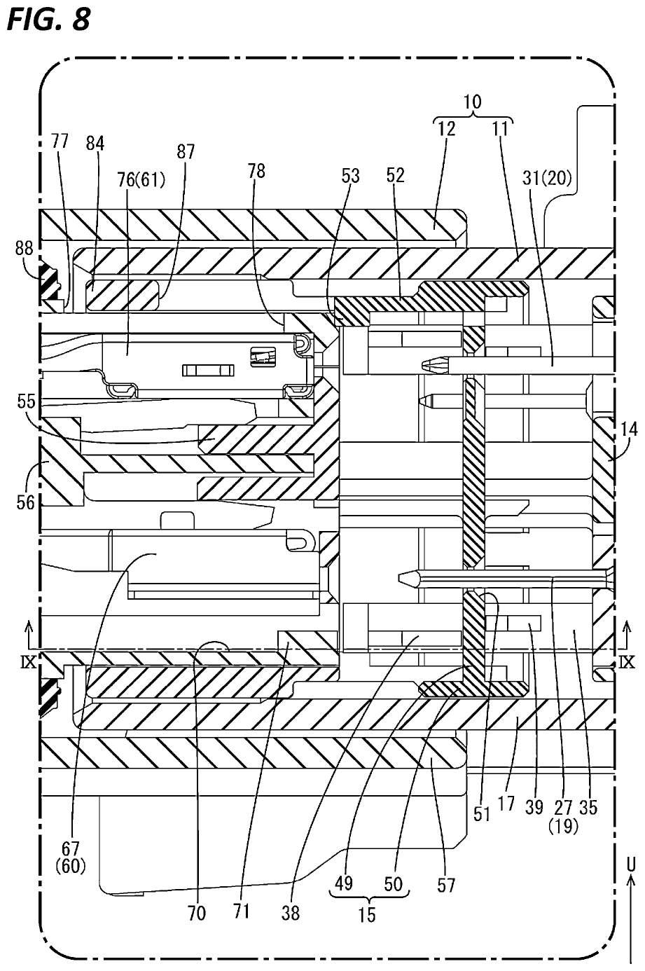

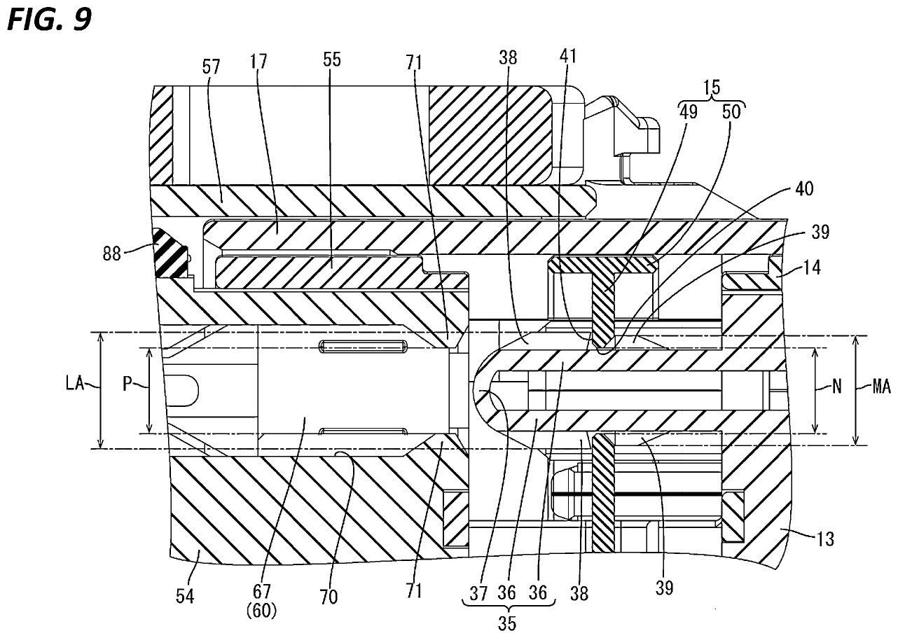

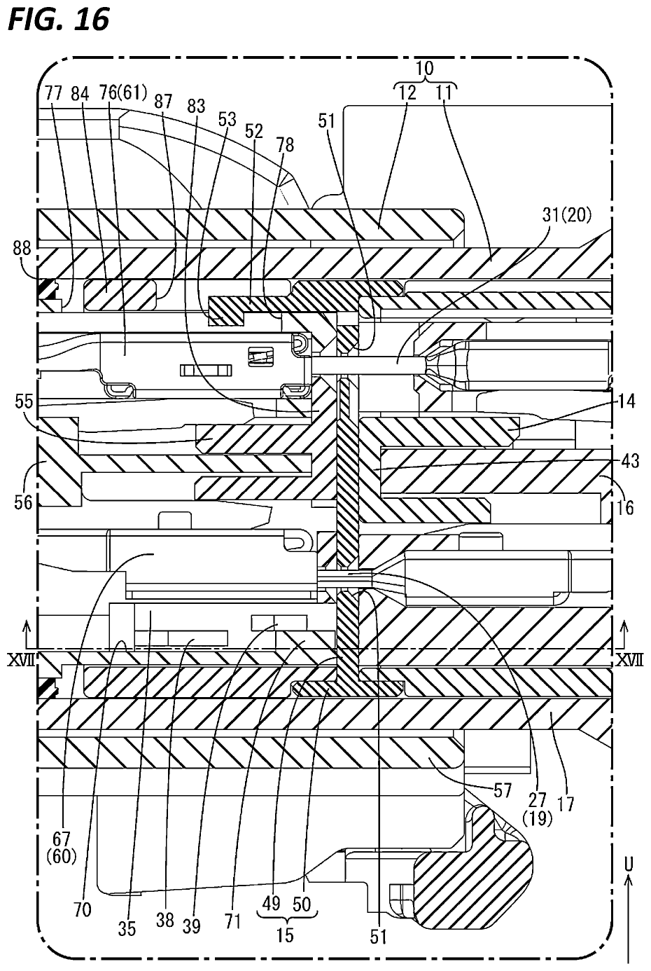

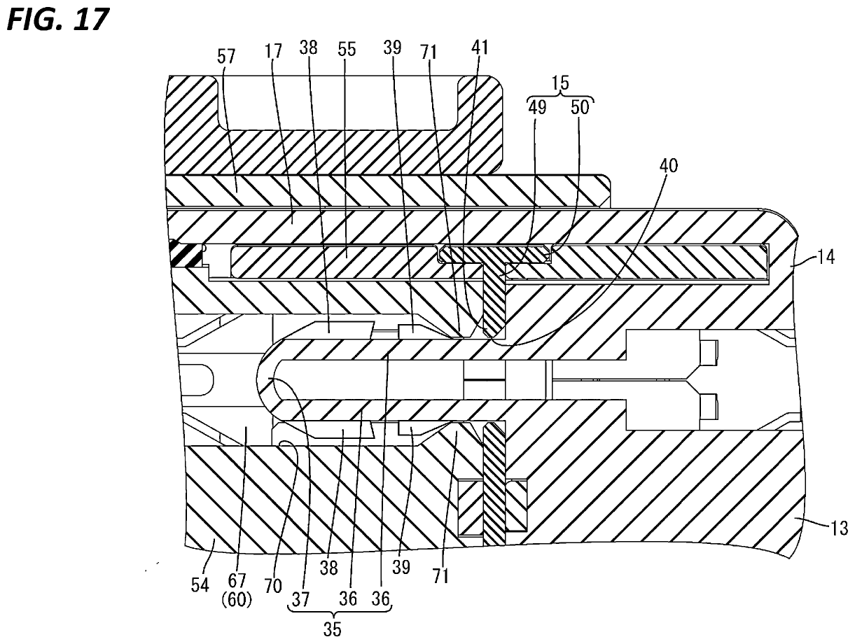

In a state inserted in the male receptacle 17, the moving plate 15 is movable in the front-rear direction between an initial position (see FIGS. 8 and 9) where the plate body 49 is located in front of and apart from the front wall portion 43 of the male retainer 14 and a connection position (see FIGS. 16 and 17), located behind the initial position in the connection direction, where the plate body 49 is in contact with the front wall portion 43 of the male retainer 14. The outer peripheral surface of the peripheral wall portion 50 guides the moving plate 15 in the front-rear direction in the male receptacle 17 by sliding in contact with the inner peripheral surface of the male receptacle 17.

As shown in FIG. 2, the plate body 49 includes positioning holes 51 at positions corresponding to the first, second and third male cavities 22, 23 and 24. The first, second and third tabs 27, 31 and 34 are inserted through the respective positioning holes 51 while being radially positioned.

The plate body 49 includes a plurality of (three in this embodiment) the moving plate through holes 48 penetrating through the plate body 49 in the front-rear direction near a center position in the vertical direction. The guide portions 47 of the male retainer 14 are inserted into the moving plate through holes 48.

As shown in FIG. 2, the plate body 49 includes the engaging hole 40 penetrating in the front-rear direction above the positioning hole 51 formed in the right upper part of the plate body 49. The moving plate lock portion 35 provided in the right upper part of the male housing 13 is inserted into the engaging hole 40. Further, the plate body 49 also includes the engaging hole 40 penetrating in the front-rear direction below the positioning hole 51 formed in the left lower part of the plate body 49. The moving plate lock portion 35 provided in the left lower part of the male housing 13 is inserted into the engaging hole 40. The engaging hole 40 and the positioning hole 51 communicate in the vertical direction. A span dimension in the lateral direction of the positioning hole 51 communicating with the engaging hole 40 is larger than that of the engaging hole 40.

As shown in FIG. 9, an interval LA between projecting end parts of the two front retaining portions 38 and an interval MA between projecting end parts of the two rear retaining portions 39 are larger than the span dimension N in the lateral direction of the engaging hole 40 in a state where no load is applied to the moving plate lock portion 35.

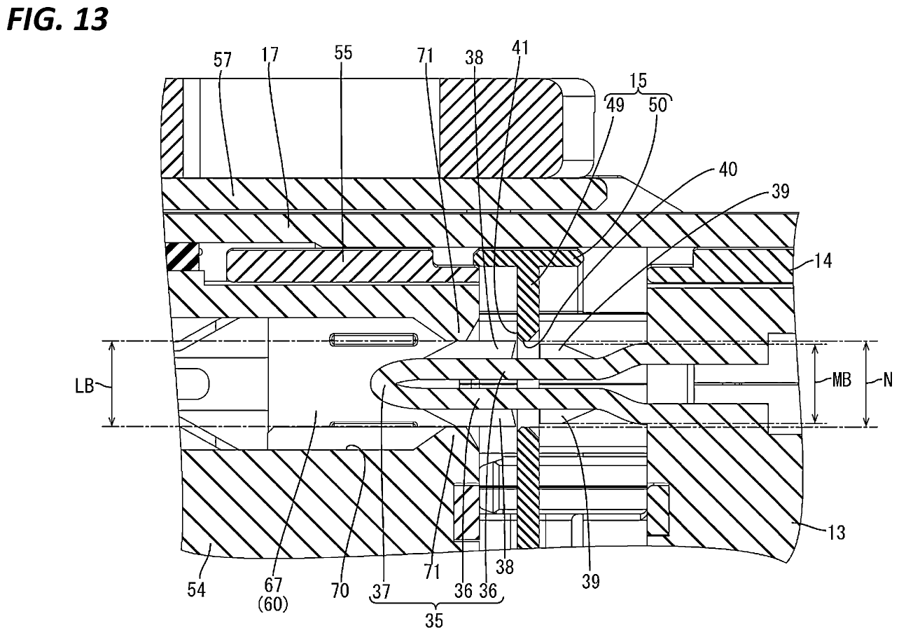

As shown in FIG. 13, in a state where a load is applied to the moving plate lock portion 35 and the two resilient deflecting portions 36 are resiliently deformed to come closer to each other, the interval LA between the projecting end parts of the two front retaining portions 38 and the interval MA between the projecting end parts of the two rear retaining portions 39 are equal or somewhat smaller than the span dimension N in the lateral direction of the engaging hole 40.

As shown in FIG. 2, retractable lock portions 52 projecting forward are respectively formed in a right lower part and a left upper part of the plate body 49. The two retractable lock portions 52 are disposed at diagonal positions centered on a central part of the plate body 49 in the vertical direction and lateral direction. The retractable lock portion 52 is in the form of a plate flat in the vertical direction, and resiliently deformable in the vertical direction. A locking claw 53 projecting upward is formed on a front end part of the retractable lock portion 52 formed in the right lower part. A locking claw 53 projecting downward is formed on a front end part of the retractable lock portion 52 formed in the left upper part. The front and rear surfaces of the locking claw 53 are steely formed (see FIG. 8).

### (Female Connector 12)

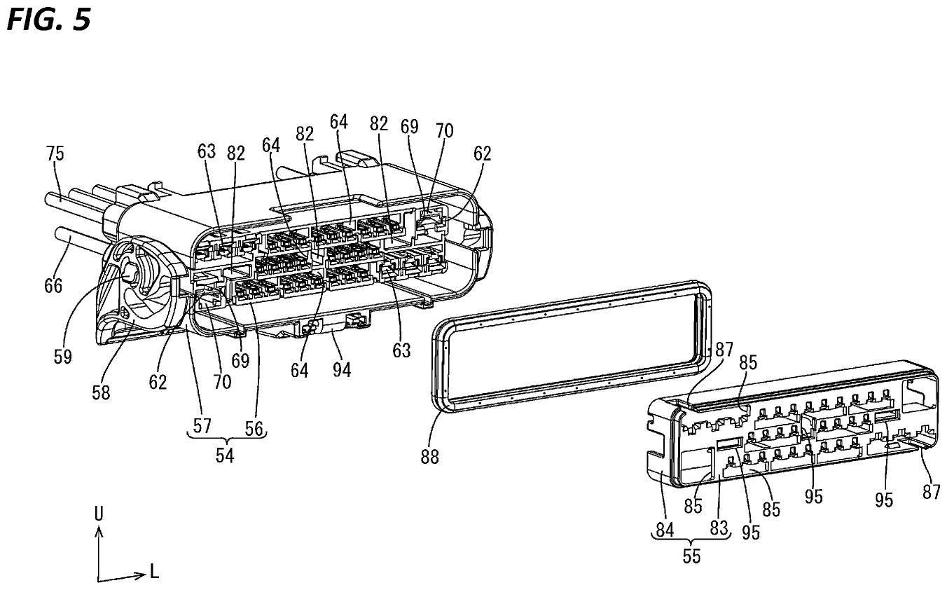

As shown in FIG. 5, the female connector 12 is provided with a female housing 54 and a female retainer 55.

### (Female Housing 54)

The female housing 54 is formed into a predetermined shape by injection-molding a synthetic resin material. As shown in FIG. 5, the female housing 54 includes a female housing body portion 56 having a substantially rectangular parallelepiped shape and a female receptacle 57 substantially in the form of a rectangular tube projecting forward from the female housing body portion 56. The female housing body portion 56 is fit into the male receptacle 17 of the male housing 13. Further, the female receptacle 57 is externally fit to the male receptacle 17 of the male housing 13.

As shown in FIG. 5, shaft portions 59, on which a lever 58 is mounted, are provided to project outward on both left and right side edge parts of the female receptacle 57. By mounting the lever 58 on the shaft portions 59, the lever 58 is mounted on the female housing 54 in a rotatable state.

As shown in FIG. 1, a plurality of (two in this embodiment) first female terminals 60 (an example of a female terminal), a plurality of (six in this embodiment) second female terminals 61 and a plurality of (twenty six in this embodiment) third female terminals (not shown) are accommodated in the female housing body portion 56. Concerning lengths in the front-rear direction, widths in the lateral direction and heights in the vertical direction, the first female terminals 60 are largest, the second female terminals 61 are second largest and the third female terminals are smallest.

As shown in FIG. 5, the female housing body portion 56 includes a plurality of (two in this embodiment) first female cavities 62 (an example of a female cavity), a plurality of (six in this embodiment) second female cavities 63 (an example of another female cavity) and a plurality of (twenty six in this embodiment) third female cavities 64. The first, second and third female cavities 62, 63 and 64 penetrate through the female housing body portion 56 in the front-rear direction.

As shown in FIG. 5, the first female cavities 62 are respectively disposed in a left upper part and a right lower part of the female housing body portion 56. Two first female cavities 62 are formed at diagonal positions centered on a central part of the female housing body portion 56 in the vertical direction and lateral direction.

As shown in FIG. 5, three second female cavities 63 arranged in the lateral direction are disposed in a right upper part of the female housing body portion 56, and three second female cavities 63 arranged in the lateral direction are disposed in a left lower part of the female housing body portion 56.

As shown in FIG. 5, the third female cavities 64 are arranged in the lateral direction in three stages in the vertical direction. Nine third female cavities 64 are disposed in an upper stage, eight third female cavities 64 are disposed in a middle stage and nine third female cavities 64 are disposed in a lower stage.

The inner wall of each of the first, second and third female cavities 62, 63 and 64 is formed with a resiliently deformable female locking lance 65 projecting forward (see FIG. 1).

As shown in FIG. 1, the first female terminal 60 is accommodated in the first female cavity 62. The first female terminal 60 is connected to a front end part of a first female wire 66 (an example of a female wire). The first female terminal 60 includes a first connecting tube portion 67 having a tubular shape. A resiliently deformable resilient contact piece (not shown) is disposed in the first connecting tube portion 67. The first tab 27 inserted into the first connecting tube portion 67 resiliently contacts the resilient contact piece, whereby the first connecting tube portion 67 and the first tab 27 are electrically connected. The female locking lance 65 resiliently locks the first connecting tube portion 67, whereby the first female terminal 60 is retained and held in the first female cavity 62.

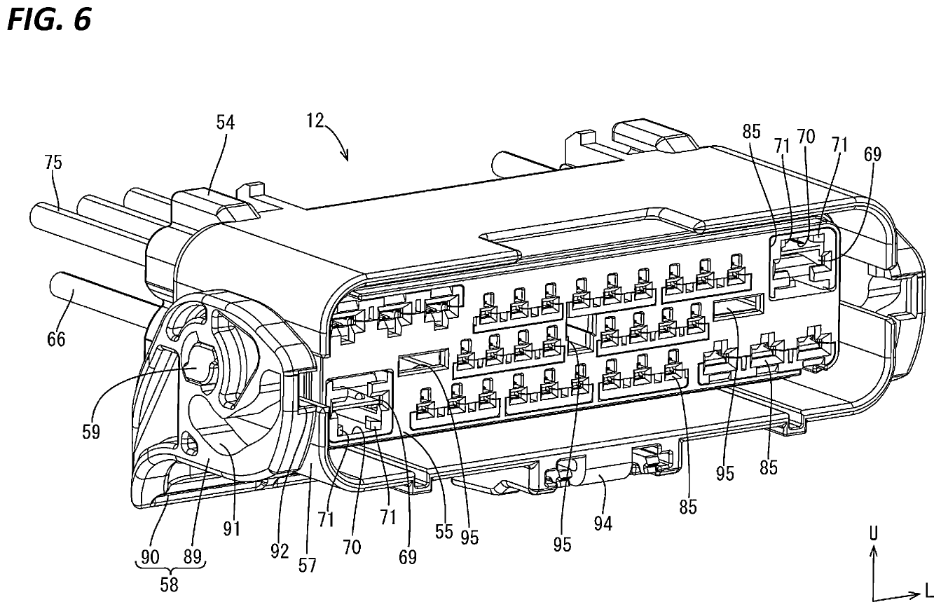

As shown in FIG. 6, the first female cavity 62 is open forward and rearward. A first tab inserting portion 69, which is provided at a position corresponding to the first tab 27 and into which the first tab 27 is inserted, and a moving plate lock inserting portion 70, which is provided at a position corresponding to the moving plate lock portion 35 and into which the moving plate lock portion 35 is inserted, are open on a front side of the first female cavity 62. The first tab inserting portion 69 and the moving plate lock inserting portion 70 communicate in the vertical direction.

As shown in FIG. 6, moving plate lock releasing portions 71 projecting inwardly of the moving plate lock inserting portion 70 are provided on both left and right side edge parts of the moving plate lock inserting portion 70. The front surface of the moving plate lock releasing portion 71 is inclined inward toward the rear side, the projecting end surface of the moving plate lock releasing portion 71 is formed to be flat in the front-rear direction, and the rear surface of the moving plate lock releasing portion 71 is inclined outward toward the rear side. The inclination of the rear surface of the moving plate lock releasing portion 71 is gentler than that of the front surface of the moving plate lock releasing portion 71.

As shown in FIG. 9, a spam dimension P between two moving plate lock releasing portions 71 in the lateral direction is smaller than the interval LA between the projecting end parts of the two front retaining portions 38 and the interval MA between the projecting end parts of the two rear retaining portions 39 in a state where no load is applied to the moving plate lock portion 35.

As shown in FIG. 1, a first female rubber plug 72 (an example of a female rubber plug) made of rubber is externally fit to the front end part of the first female wire 66. In this way, an outer peripheral part of the first female wire 66 and the inner peripheral surface of the first female rubber plug 72 are held in close contact, with the result that liquid-tight sealing is provided between the first female wire 66 and the first female rubber plug 72. The first female rubber plug 72 has a substantially hollow cylindrical shape. A rear end part of the first female cavity 62 is formed with a first female sealing portion 73 (an example of a female sealing portion), into which the first female rubber plug 72 is fit. The first female sealing portion 73 has a hollow cylindrical shape. An inner diameter of the first female sealing portion 73 is set to be somewhat smaller than an outer diameter of the first female rubber plug 72. In this way, the first female rubber plug 72 is resiliently compressed while being fit in the first female sealing portion 73. As a result, an outer peripheral part of the first female rubber plug 72 is held in close contact with the inner peripheral surface of the first female sealing portion 73, wherefore liquid-tight sealing is provided between the first female rubber plug 72 and the first female cavity 62.

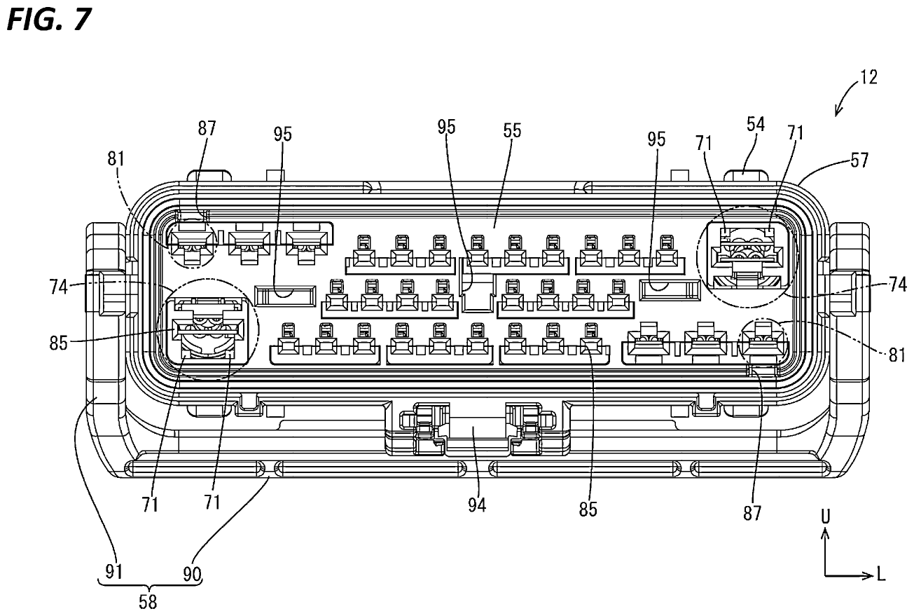

As shown in FIGS. 1 and 7, a virtual surface set by extending the inner surface of the first female sealing portion 73 forward is a virtual first female sealing surface 74 (an example of a virtual female sealing surface). The virtual first female sealing surface 74 is a virtual surface extending forward of the first female sealing portion 73 and having a hollow cylindrical shape. The moving plate lock releasing portions 71 are formed in a region inside this virtual first female sealing surface 74. In this way, when the female housing 54 is molded by a mold, which is opened in the front-rear direction, the first female cavities 62 can serve as mold removal holes for forming the moving plate lock releasing portions 71.

As shown in FIG. 1, the second female terminal 61 is accommodated in the second female cavity 63. The second female terminal 61 is connected to a front end part of a second female wire 75 (an example of another female wire). The second female terminal 61 includes a second connecting tube portion 76 having a tubular shape. A resiliently deformable resilient contact piece (not shown) is disposed in the second connecting tube portion 76. The second tab 31 inserted into the second connecting tube portion 76 resiliently contacts the resilient contact piece, whereby the second connecting tube portion 76 and the second tab 31 are electrically connected. The female locking lance 65 resiliently locks the second connecting tube portion 76, whereby the second female terminal 61 is retained and held in the second female cavity 63.

As shown in FIG. 1, the female housing 54 body is formed with recesses 77 extending rearward from positions somewhat behind the front end part of the female housing 54 body at positions corresponding to the second female cavities 63. The recess 77 communicates with the second female cavity 63 in the vertical direction. A front end part of the recess 77 serves as a retractable lock receiving portion 78 to be locked from behind by the locking claw 53 of the retractable lock portion 52 of the moving plate 15. The retractable lock receiving portion 78 is formed to be upright in the vertical direction. A width in the lateral direction of the recess 77 is equal to or somewhat larger than that of the retractable lock portion 52.

A second female rubber plug 79 (an example of another female rubber plug) made of rubber is externally fit to the front end part of the second female wire 75. In this way, an outer peripheral part of the second female wire 75 and the inner peripheral surface of the second female rubber plug 79 are held in close contact, with the result that liquid-tight sealing is provided between the second female wire 75 and the second female rubber plug 79. The second female rubber plug 79 has a substantially hollow cylindrical shape. A rear end part of the second female cavity 63 is formed with a second female sealing portion 80 (an example of another female sealing portion), into which the second female rubber plug 79 is fit. The second female sealing portion 80 has a hollow cylindrical shape. An inner diameter of the second female sealing portion 80 is set to be somewhat smaller than an outer diameter of the second female rubber plug 79. In this way, the second female rubber plug 79 is resiliently compressed while being fit in the second female sealing portion 80. As a result, an outer peripheral part of the second female rubber plug 79 is held in close contact with the inner peripheral surface of the second female sealing portion 80, wherefore liquid-tight sealing is provided between the second female rubber plug 79 and the second female cavity 63.

As shown in FIGS. 1 and 7, a virtual surface set by extending the inner surface of the second female sealing portion 80 forward is a virtual second female sealing surface 81 (an example of another virtual female sealing surface). The virtual second female sealing surface 81 is a virtual surface extending forward of the second female sealing portion 80 and having a hollow cylindrical shape. The retractable lock receiving portion 78 is formed in a region inside this virtual second female sealing surface 81. In this way, when the female housing 54 is molded by the mold, which is opened in the front-rear direction, the second female cavities 63 can serve as mold removal holes for forming the retractable lock receiving portions 78.

The third female terminal is accommodated in the third female cavity 64. The third female terminal is connected to a front end part of a third female wire. The third female terminal includes a third connecting tube portion (not shown) having a tubular shape. A resiliently deformable resilient contact piece (not shown) is disposed in the third connecting tube portion. The third tab 34 inserted into the third connecting tube portion resiliently contacts the resilient contact piece, whereby the third connecting tube portion and the third tab 34 are electrically connected. The female locking lance 65 resiliently locks the third connecting tube portion, whereby the third terminal is retained and held in the third female cavity 64.

A third female rubber plug (not shown) made of rubber is externally fit to the front end part of the third female wire. In this way, an outer peripheral part of the third female wire and the inner peripheral surface of the third female rubber plug are held in close contact, with the result that liquid-tight sealing is provided between the third female wire and the third female rubber plug. The third female rubber plug has a substantially hollow cylindrical shape. A rear end part of the third female cavity 64 is formed with a third female sealing portion (not shown), into which the third female rubber plug is fit. The third female sealing portion has a hollow cylindrical shape. An inner diameter of the third female sealing portion is set to be somewhat smaller than an outer diameter of the third female rubber plug. In this way, the third female rubber plug is resiliently compressed while being fit in the third female sealing portion. As a result, an outer peripheral part of the third female rubber plug is held in close contact with the inner peripheral surface of the third female sealing portion, wherefore liquid-tight sealing is provided between the third female rubber plug and the third female cavity 64.

As shown in FIG. 5, the front end part of the female housing body portion 56 is provided with guide recesses 82 recessed rearward near a center position in the vertical direction. The guide portions 47 of the male retainer 14 are inserted into the guide recesses 82. The inner shape of the guide recess 82 is the same as or somewhat larger than the outer shape of the guide portion 47 of the male retainer 14.

### (Female Retainer 55)

The female retainer 55 is mounted on the front end part of the female housing body portion 56 from front. The female retainer 55 is made of synthetic resin and includes a plate-like front wall portion 83 and a peripheral wall portion 84 extending rearward from a peripheral edge part of the front wall portion 83 as shown in FIG. 5. The peripheral wall portion 84 of the female retainer 55 is externally fit to the front end part of the female housing body portion 56.

A plurality of female retainer-side insertion holes 85 penetrate through the front wall portion 83 in the front-rear direction. The first, second and third tabs 27, 31 and 34 are respectively inserted through the respective female retainer-side insertion holes 85.

As shown in FIG. 1, a plurality of female deflection restricting portions 86 projecting rearward are formed on the rear surface of the front wall portion 83. The female deflection restricting portion 86 is in the form of a plate flat in the vertical direction and extending in the lateral direction. When the female retainer 55 is mounted at a proper position on the female housing body portion 56, the female deflection restricting portions 86 enter deflection spaces for the female locking lances 65. In this way, the female locking lances 65 are suppressed from being deflected and deformed, wherefore the first female terminals 60, the second female terminals 61 and the third female terminals are secondarily retained in the female housing body portion 56.

As shown in FIG. 5, the front wall portion 83 includes female retainer through holes 95 penetrating through the front wall portion 83 in the front-rear direction near a center position in the vertical direction and a center position in the lateral direction. The female retainer through holes 95 are provided at positions corresponding to the guide recesses 82 of the female housing body portion 56. The guide portions 47 of the male retainer 14 are inserted into the female retainer through holes 95. The inner shape of the female retainer through hole 95 is the same as or somewhat larger than the outer shape of the guide portion 47 of the male retainer 14.

As shown in FIG. 5, a cut portion 87 cut rearward from the front end edge of the peripheral wall portion 84 is provided at a position near a right end part of an upper edge part of the peripheral wall portion 84. Further, a cut portion 87 cut rearward from the front end edge of the peripheral wall portion 84 is also provided at a position near a left end part of a lower edge part of the peripheral wall portion 84. In a part where the cut portion 87 is provided, a region inside the peripheral wall portion 84 and a region outside the peripheral wall portion 84 communicate. The cut portions 87 are formed at positions corresponding to the recesses 77. A span dimension in the lateral direction of the cut portion 87 is equal to or somewhat larger than a width in the lateral direction of the retractable lock portion 52.

As shown in FIG. 1, a sealing ring 88 is externally fit to the female housing 54 body at a position behind the female retainer 55 and behind rear end parts of the recesses 77. When the female and male connector 12, 11 are connected, the sealing ring 88 is sandwiched between the female housing 54 body and the male receptacle 17, whereby liquid-tight sealing is provided between the female and male connectors 12, 11.

### (Lever 58)

The lever 58 is made of synthetic resin and, as shown in FIG. 6, provided with a pair of cam plate portions 89 and a coupling portion 90 coupling the pair of cam plate portions 89. The pair of cam plate portions 89 are arranged in parallel to face each other, and mounted on the shaft portions 59 to sandwich the female receptacle 57 of the female housing 54 in the lateral direction.

The cam plate portion 89 is plate-like and includes a cam groove 91 for receiving the cam pin 18. The shaft portion 59 is passed through the cam plate portion 89. The cam plate portion 89 is rotatable about the shaft portion 59. The cam groove 91 is in the form of a groove penetrating through the cam plate portion 89. The cam groove 91 includes an entrance opening 92 for allowing the entrance of the cam pin 18 on one edge of the cam plate portion 89. The cam groove 91 has an arcuate shape to gradually approach the shaft portion 59, which is a center of rotation of the cam plate portion 89, from the entrance opening 92 toward a back side.

The coupling portion 90 is provided with a locking portion 93 near a center position in the lateral direction (see FIG. 1). The locking portion 93 is disposed to be locked to a lock portion 94 (see FIG. 6) provided on the outer surface of the female receptacle 57.

The lever 58 is mounted to straddle the female housing 54 by arranging the pair of cam plate portions 89 along side wall parts of the female receptacle 57 and fitting the shaft portions 59 into the cam plate portions 89. The lever 58 is supported rotatably between a connection start position where the entrance of the cam pins 18 into the cam plate portions 89 is allowed and a connection completion position where the male connector 11 is connected at a proper connection position to the female connector 12.

### (Assembly Process of Moving Plate 15)

The male retainer 14 is mounted on the front end part of the male housing 13 body. The moving plate 15 is inserted into the male receptacle 17 from front. The moving plate 15 approaches the moving plate lock portions 35 of the male housing 13 from front, whereby front end parts of the moving plate lock portions 35 are inserted into the engaging holes 40 of the moving plate 15. Then, the front retaining portions 38 of each moving plate lock portion 35 slide in contact with the hole edge part of the engaging hole 40, whereby the two resilient deflecting portions 36 are resiliently deformed in the directions toward each other. By moving the moving plate 15 further rearward, the hole edge part of the engaging hole 40 rides over the front retaining portions 38. Then, the two resilient deflecting portions 36 are restored. In this way, the moving plate 15 is fit at a position between the front retaining portions 38 and the rear retaining portions 39 of the moving plate lock portions 35. In this state, the rear surfaces of the front retaining portions 38 come into contact with the front surface of the moving plate 15, whereby the moving plate 15 is restricted from coming out forward. Further, the front surfaces of the rear retaining portions 39 come into contact with the rear surface of the moving plate 15, whereby the moving plate 15 is restricted from coming out rearward. In this way, the moving plate 15 is held at the initial position with respect to the male housing 13 (see FIG. 9).

When the moving plate 15 is at the initial position, the guide portions 47 of the male retainer 14 are inserted into the moving plate through holes 48 of the plate body 49.

With the first, second and third male terminals 19, 20 and 21 held in the male housing body portion 16, the first, second and third tabs 27, 31 and 34 project into the male receptacle 17. When the moving plate 15 is at the initial position, the first, second and third tabs 27, 31 and 34 are respectively inserted into the positioning holes 51 (see FIG. 8). In this way, the first, second and third tabs 27, 31 and 34 are protected by the moving plate 15 while tip parts thereof are inserted and positioned in the positioning holes 51 of the plate body 49.

### (Connection Process of Male Connector 11 and Female Connector 12)

As shown in FIGS. 8 and 9, the male and female connectors 11, 12 are brought closer and the female housing 54 body having the female retainer 55 mounted thereon is lightly inserted into the male receptacle 17. If the male and female connectors 11, 12 are brought even closer by rotating the lever 58, the guide portions 47 of the male retainer 14 enter the female retainer through holes 95 of the female retainer 55 and the guide recesses 82 of the female housing body portion 56. In this way, the male and female connectors 11, 12 are guided in the front-rear direction by the guide portions 47.

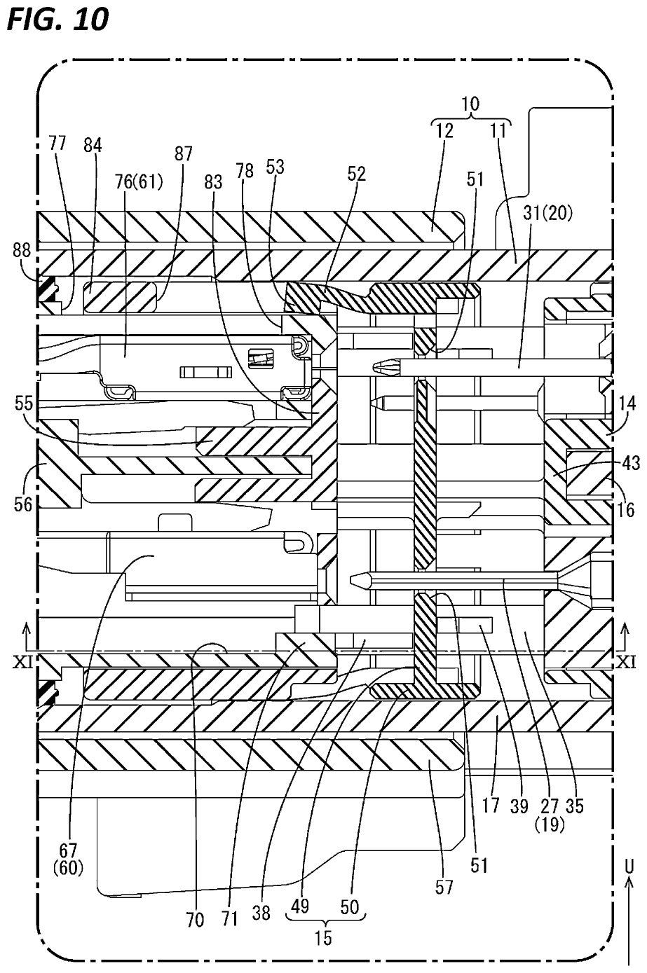

If the male and female connectors 11, 12 are brought even closer, the retractable lock portions 52 of the moving plate 15 come into contact with the front end edge of the female housing body portion 56 and are resiliently deformed to ride on the front end edge of the female housing body portion 56 as shown in FIGS. 10 and 11.

Further, the moving plate lock releasing portions 71 of the female housing body portion 56 come into contact with the front retaining portions 38 of the moving plate lock portions 35.

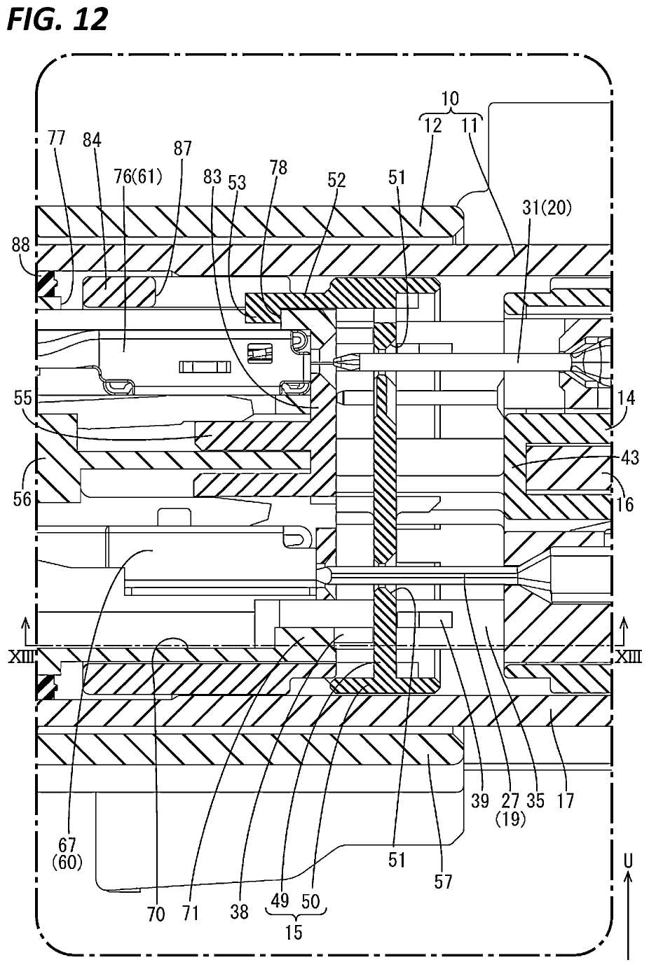

If the male and female connectors 11, 12 are brought even closer, the retractable lock portions 52 of the moving plate 15 are restored and enter the recesses 77 of the female housing body portion 56 as shown in FIG. 12.

Further, as shown in FIG. 13, the moving plate lock releasing portions 71 of the female housing body portion 56 come into contact with the front retaining portions 38 of each moving plate lock portion 35, whereby the two resilient deflecting portions 36 are resiliently deformed in the directions toward each other. In this way, the hole edge part of the engaging hole 40 of the moving plate 15 is separated from the front retaining portions 38 and the rear retaining portions 39. As a result, a locked state of the moving plate lock portions 35 and the moving plate 15 is released and the moving plate 15 becomes movable in the front-rear direction.

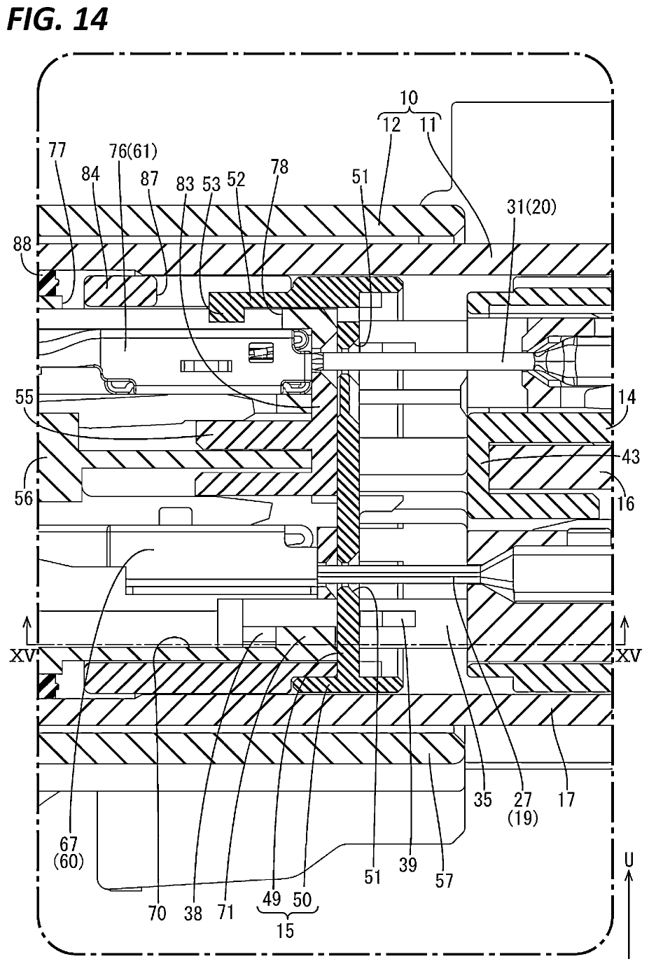

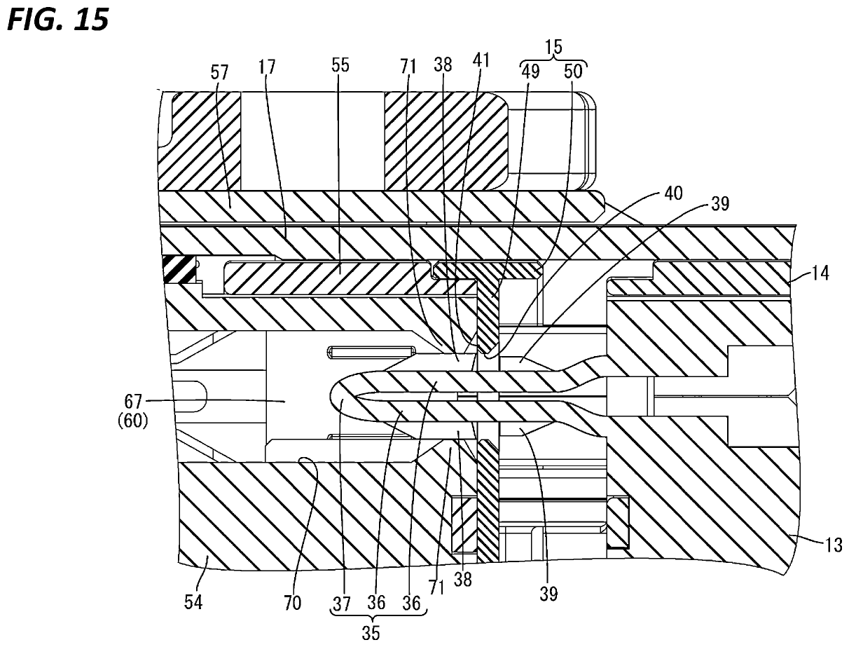

If the male and female connectors 11, 12 are brought even closer, the front end part of the female housing body portion 56 and the front wall portion 83 of the female retainer 55 come into contact with the front surface of the moving plate 15 as shown in FIGS. 14 and 15 and the moving plate 15 moves rearward toward the connection position.

If the female connector 12 body portion is properly inserted into the male receptacle 17, the locking portion 93 of the lever 58 is locked to the lock portion 94 of the female housing body portion 56. In this state, the plate body 49 comes into contact with the front wall portion 43 of the male retainer 14 and the front end part of the male housing body portion 16 (see FIGS. 16 and 17). In this way, the male and female connectors 11, 12 are properly connected. In this state, the first tabs 27 of the first male terminals 19 are inserted into the first connecting tube portions 67 of the first female terminals 60 and the first male terminals 19 and the second female terminals 61 are electrically connected. Similarly, the second tabs 31 of the second male terminals 20 are inserted into the second connecting tube portions 76 of the second female terminals 61 and the second male terminals 20 and the second female terminals 61 are electrically connected, and the third tabs 34 of the third male terminals 21 are inserted into the third connecting tube portions of the third female terminals and the third male terminals 21 and the second female terminals are electrically connected (see FIG. 1).

### (Separation Process of Male Connector 11 and Female Connector 12)

In separating the male and female connectors 11, 12 for a reason such as maintenance, the locking of the locking portion 93 of the lever 58 and the lock portion 94 of the female housing body portion 56 is first released and the lever 58 is rotated toward the connection start position. Then, the female and male connectors 12, 11 relatively move in directions separating from each other.

If the female connector 12 moves rearward, the moving plate lock releasing portions 71 of the female connector 12 come into contact with the rear retaining portions 39 of each moving plate lock portion 35 and the two resilient deflecting portions 36 are resiliently deformed in the directions toward each other as shown in FIG. 13. If the female connector 12 moves further rearward, the moving plate lock releasing portions 71 of the female connector 12 come into contact with the front retaining portions 38 of each moving plate lock portion 35 and the two resilient deflecting portions 36 are resiliently deformed in the directions toward each other. In this state, the moving plate 15 becomes movable in the front-rear direction.

As shown in FIG. 12, the retractable lock receiving portions 78 of the female housing 54 body come into contact with the retractable lock portions 52 from front (front when viewed from the male connector 11). In this way, the moving plate 15 moves forward by being pushed by the retractable lock receiving portions 78.

If the male and female connectors 11, 12 further move in the directions separating from each other, the moving plate lock releasing portions 71 of the female housing body portion 56 are separated from the front retaining portions 38 as shown in FIG. 11. In this way, the two resilient deflecting portions 36 are restored. As a result, the hole edge part of each engaging hole 40 of the moving plate 15 is fit into the gaps between the front retaining portions 38 and the rear retaining portions 39. Then, the front surface of the moving plate 15 come into contact with the rear surfaces of the front retaining portions 38, whereby a forward movement of the moving plate 15 is restricted.

If the male and female connectors 11, 12 further move in the directions separating from each other, the retractable lock portions 52 of the moving plate 15 are resiliently deformed to ride on the retractable lock receiving portions 78 as shown in FIG. 10. In this way, the retractable lock portions 52 of the moving plate 15 and the retractable lock receiving portions 78 of the female housing body portion 56 are disengaged.

If the male and female connectors 11, 12 further move in the directions separating from each other, the retractable lock portions 52 of the moving plate 15 are restored. In this way, the moving plate 15 is held at the initial position in the male receptacle 17 of the male connector 11 when the female and male connectors 12, 11 are separated.

### Functions and Effects of Embodiment

Next, functions and effects of this embodiment are described. According to this embodiment, in forming the moving plate lock portions 35 using the mold, which is opened forward and rearward in demolding, the first male cavities 22 can serve as mold removal holes. In this way, the mold removal holes need not be separately formed in the male housing 13, wherefore the rear surface of the male housing 13 needs not be collectively sealed by one one-piece rubber plug. As a result, the respective male cavities 22, 23 and 24 can be individually sealed such as the sealing of the first male cavities 22 by the first male rubber plugs 28, the sealing of the second male cavities 23 by the second male rubber plugs 32 and the sealing of the third male cavities 24 by the third male rubber plugs. Thus, manufacturing cost can be reduced as compared to the case of using the one-piece rubber plug. Further, by individually sealing the respective male cavities 22, 23 and 24, the waterproofness of the male housing 13 can be improved as compared to the case where the rear surface of the male housing 13 is collectively sealed by one one-piece rubber plug.

Further, according to this embodiment, in forming the moving plate lock releasing portions 71 using the mold, which is opened forward and rearward in demolding, the first female cavities 62 can serve as mold removal holes. In this way, the mold removal holes need not be separately formed in the female housing 54, wherefore the rear surface of the female housing 54 needs not be collectively sealed by one one-piece rubber plug. As a result, the respective female cavities 62, 63 and 64 can be individually sealed such as the sealing of the first female cavities 62 by the first female rubber plugs 72, the sealing of the second female cavities 63 by the second female rubber plugs 79 and the sealing of the third female cavities 64 by the third female rubber plugs. Thus, manufacturing cost can be reduced as compared to the case of using the one-piece rubber plug. Further, by individually sealing the respective female cavities 62, 63 and 64, the waterproofness of the female housing 54 can be improved as compared to the case of using the one-piece rubber plug.

Further, according to this embodiment, in forming the retractable lock receiving portions 78 using the mold, which is opened forward and rearward in demolding, the second female cavities 63 can serve as mold removal holes. In this way, the mold removal holes need not be separately formed in the female housing 54, wherefore the rear surface of the female housing 54 needs not be collectively sealed by one one-piece rubber plug. As a result, the respective female cavities 62, 63 and 64 can be individually sealed such as the sealing of the first female cavities 62 by the first female rubber plugs 72, the sealing of the second female cavities 63 by the second female rubber plugs 79 and the sealing of the third female cavities 64 by the third female rubber plugs. Thus, manufacturing cost can be reduced as compared to the case of using the one-piece rubber plug. Further, by individually sealing the respective female cavities 62, 63 and 64, the waterproofness of the female housing 54 can be improved as compared to the case of using the one-piece rubber plug.

Further, according to this embodiment, the moving plate lock portion 35 is formed to be resiliently deformable in the directions intersecting the extension direction of the first tab 27 and parallel to the plate surfaces of the first tab 27. In this way, even if the moving plate lock portion 35 is resiliently deformed, the interference of the moving plate lock portion 35 and the first tab 27 can be avoided. In this way, a region where the moving plate lock portion 35 is resiliently deformed can be provided without enlarging the male connector 11.

Further, according to this embodiment, the moving plate lock portion 35 includes the two resilient deflecting portions 36 extending forward in the connection direction and the reinforcing portion 37 coupling the tip parts of the two resilient deflecting portions 36 to each other. In this way, the resilient deflecting portions 36 can be strengthened by the reinforcing portion 37, wherefore the strength of the moving plate lock portion 35 can be improved. In this way, unintended deformation of the moving plate lock portion 35 is suppressed, with the result that an unintended movement of the moving plate 15 from the initial position can be suppressed.

### Other Embodiments

(1) The moving plate lock portion 35 may be formed to be resiliently deformable in directions intersecting the plate surfaces of the first tab 27.
(2) The reinforcing portion 37 may be omitted. Further, the moving plate lock portion 35 may be formed by one resilient deflecting piece.
(3) The lever 58 may be omitted.

List of Reference Numerals

| | |
|---|---|
| 10: | connector pair |
| 11: | male connector |
| 12: | female connector |
| 13: | male housing |
| 14: | male retainer |
| 15: | moving plate |
| 16: | male housing body portion |
| 17: | male receptacle |
| 18: | cam pin |
| 19: | first male terminal |
| 20: | second male terminal |
| 21: | third male terminal |
| 22: | first male cavity |
| 23: | second male cavity |
| 24: | third male cavity |
| 25: | male locking lance |
| 26: | first male wire |
| 27: | first tab |
| 28: | first male rubber plug |
| 29: | first male sealing portion |
| 30: | second male wire |
| 31: | second tab |
| 32: | second male rubber plug |
| 33: | second male sealing portion |
| 34: | third male wire |
| 35: | moving plate lock portion |
| 36: | resilient deflecting portion |
| 37: | reinforcing portion |
| 38: | front retaining portion |
| 39: | rear retaining portion |
| 40: | engaging hole |
| 41: | moving plate lock receiving portion |
| 42: | virtual male sealing surface |
| 43: | front wall portion |
| 44: | peripheral wall portion |
| 45: | male retainer-side insertion hole |
| 46: | male deflection restricting portion |
| 47: | guide portion |
| 48: | moving plate through hole |
| 49: | plate body |
| 50: | peripheral wall portion |
| 51: | positioning hole |
| 52: | retractable lock portion |
| 53: | locking claw |
| 54: | female housing |
| 55: | female retainer |
| 56: | female housing body portion |
| 57: | female receptacle |
| 58: | lever |
| 59: | shaft portion |
| 60: | first female terminal |
| 61: | second female terminal |
| 62: | first female cavity |
| 63: | second female cavity |
| 64: | third female cavity |
| 65: | female locking lance |
| 66: | first female wire |
| 67: | first connecting tube portion |
| 69: | first tab inserting portion |
| 70: | moving plate lock inserting portion |
| 71: | moving plate lock releasing portion |
| 72: | first female rubber plug |
| 73: | first female sealing portion |
| 74: | virtual first female sealing surface |
| 75: | second female wire |
| 76: | second connecting tube portion |
| 77: | recess |
| 78: | retractable lock receiving portion |
| 79: | second female rubber plug |
| 80: | second female sealing portion |
| 81: | virtual second female sealing surface |
| 82: | guide recess |
| 83: | front wall portion |
| 84: | peripheral wall portion |
| 85: | female retainer-side insertion hole |
| 86: | female deflection restricting portion |
| 87: | cut portion |
| 88: | sealing ring |
| 89: | cam plate portion |
| 90: | coupling portion |
| 91: | cam groove |
| 92: | entrance opening |
| 93: | locking portion |
| 94: | lock portion |
| 95: | female retainer through hole |

1. A male connector to be connected to a female connector along a connection direction, comprising:
a male housing including a male receptacle;
a male terminal to be mounted into the male housing, the male terminal including a tab projecting into the male receptable;
a male wire to be attached to the male terminal;
a male rubber plug to be externally fit to the male wire; and
a moving plate to be disposed in the male receptacle, the moving plate being movable between an initial position and a connection position behind the initial position in the connection direction while positioning the tab,
the male housing including a male cavity for accommodating the male terminal, the male cavity including a tubular male sealing portion, the male rubber plug being fit into the male sealing portion, an inner surface of the male sealing portion being held in close contact with the male rubber plug, and
the male housing including a moving plate lock portion in a region inside a virtual male sealing surface set by extending the inner surface of the male sealing portion forward in the connection direction, the moving plate lock portion projecting forward in the connection direction, the moving plate lock portion holding the moving plate at the initial position by being engaged with the moving plate.

2. The male connector of claim 1, wherein the moving plate lock portion is formed to be resiliently deformable in a direction intersecting an extension direction of the tab and parallel to plate surfaces of the tab.

3. The male connector of claim 1, wherein the moving plate lock portion includes two resilient deflecting portions extending forward in the connection direction and a reinforcing portion coupling tip parts of the two resilient deflecting portions to each other.

4. A connector pair, comprising:
the male connector of claim 1; and
a female connector to be connected to the male connector,
the female connector including a female housing having a female receptacle to be externally fit to the male receptacle, a female terminal to be mounted into the female housing and electrically connected to the male terminal, a female wire to be attached to the female terminal, and a female rubber plug to be externally fit to the female wire,
the female housing including a female cavity for accommodating the female terminal, the female cavity including a tubular female sealing portion, the female rubber plug being fit into the female sealing portion, an inner surface of the female sealing portion being held in close contact with the female rubber plug, and
the female housing including a moving plate lock releasing portion in a region inside a virtual female sealing surface set by extending the inner surface of the female sealing portion forward in the connection direction, the moving plate lock releasing portion projecting forward in the connection direction, the moving plate lock releasing portion disengaging the moving plate and the moving plate lock portion by resiliently deforming the moving plate lock portion.

5. The connector pair of claim 4, wherein:
the moving plate includes a resiliently deformable retractable lock portion projecting forward in the connection direction,
the female connector includes another female terminal to be mounted into the female housing and different from the female terminal, another female wire to be attached to the other female terminal and another female rubber plug to be externally fit to the other female wire,
the female housing includes a retractable lock receiving portion lockable by the retractable lock portion,
the female housing includes another female cavity for accommodating the other female terminal, the other female cavity including another tubular female sealing portion, the other female rubber plug being fit into the other female sealing portion, and an inner surface of the other female sealing portion is held in close contact with the other female rubber plug, and
the female housing includes the retractable lock receiving portion in a region inside another virtual female sealing surface set by extending the inner surface of the other female sealing portion in the connection direction.
